(19) United States
(12) Patent Application Publication
(10) Pub. No.: US 2025/0070998 A1
(43) Pub. Date: Feb. 27, 2025

(54) TENANT-SPECIFIC VIRTUAL TUNNEL ENDPOINTS FOR VXLANS

(71) Applicant: Equinix, Inc., Redwood City, CA (US)

(72) Inventor: Syed Hashim Iqbal, San Jose, CA (US)

(21) Appl. No.: 18/455,366

(22) Filed: Aug. 24, 2023

(51) Int. Cl. H04L 12/46

(52) U.S. Cl. CPC H04L 12/4641; H04L 12/4633

(57) ABSTRACT

In general, this disclosure describes techniques for enabling multiple Virtual Extensible LAN (VXLAN) Virtual Tunnel Endpoints (VTEPs) per compute node within a computing infrastructure. In one example, a computing device comprises a network interface controller (NIC) and processing circuitry having access to storage media encoded with instructions, the processing circuitry configured to receive, by a main packet processor, a packet from the NIC. The processing circuitry is further configured to send, by the main packet processor, based on a virtual extensible local area network (VXLAN) tunnel endpoint (VTEP) indicated by a packet, the packet to a tenant-specific packet processor associated with the VTEP. The processing circuitry is further configured to send, by the tenant-specific packet processor, at least a portion of the packet to a workload. The processing circuitry is further configured to process, by the workload, the at least a portion of the packet.

### TECHNICAL FIELD

The disclosure relates to computer networks and, more specifically, to multi-tenancy.

### BACKGROUND

In a typical cloud data center environment, there is a large collection of interconnected servers that provide computing (“compute nodes”) and/or storage capacity (“storage nodes”) to run various applications. For example, a data center may comprise a facility that hosts applications and services for customers or tenants of a data center. The data center may, for example, host all of the infrastructure equipment, such as networking and storage systems, redundant power supplies, and environmental controls. In a typical data center, clusters of storage systems and application servers are interconnected via high-speed switch fabric provided by one or more tiers of physical network switches and routers. More sophisticated data centers provide infrastructure spread throughout the world with subscriber support equipment located in various physical hosting facilities.

Virtualized data centers are becoming a core foundation of the modern information technology (IT) infrastructure. In particular, modern data centers have extensively utilized virtualized environments in which virtual hosts, also referred to herein as virtual compute instances, such as virtual machines or containers, are deployed and executed on an underlying compute platform of physical computing devices.

Virtual Extensible LAN (VXLAN) is a network virtualization technology that attempts to address the scalability problems associated with large computing deployments, which may span one or more data centers. VXLAN encapsulates Layer 2 Ethernet frames within Layer 4 UDP datagrams. VXLAN uses a 24-bit VXLAN network identifier (VNI) (sometimes referred to as a “virtual network identifier”) to identify each virtual network. VXLAN endpoints, which terminate VXLAN tunnels and may be either virtual or physical ports, are known as VXLAN tunnel endpoints (VTEPs). A VTEP is responsible for encapsulating and decapsulating the Ethernet frames and forwarding packets between the physical and virtual networks. A VTEP has two interfaces: a switch interface on a local network segment to support local endpoint communication and an IP interface to the transport IP network.

### SUMMARY

In general, this disclosure describes techniques for enabling multiple Virtual Extensible LAN (VXLAN) Virtual Tunnel Endpoints (VTEPs) per compute node within a computing infrastructure. As a result, the techniques enable assigning VTEPs to tenants hosted by computing infrastructure such that one or more VTEPs are specific to each tenant, and the flood-list for a given VNI for a tenant may be made specific to those compute nodes presenting a VTEP assigned to the tenant.

The techniques may leverage network virtualization within a compute node. For example, a main packet processor executing on a compute node may be configured to direct packets, received at an underlay network address for the compute node, to one of multiple tenant-specific packet processors each also executing on the compute node and each presenting a virtual network address for a VTEP. The main packet processor directs packets to a particular tenant-specific packet processor based on a virtual destination address of the overlay packet matching the virtual network address for the VTEP for that tenant-specific packet processor. In this example, packet processors may in this way be chained to provide service isolation among tenants using namespaces that are commensurate with the tenant-specific VTEPs.

The techniques provide one or more technical advantages that may be used to realize one or more practical applications. For example, by assigning and using tenant-specific VTEPs within computing devices, rather than solely relying on the VNIs for implementing multi-tenancy, the techniques may reduce the size of the flood list(s) and reduce the amount of flooding of broadcast, unidentified unicast, and multicast (BUM) traffic across compute/metro/regions hosting distributed tenant workloads. This reduction in flooding may consequently reduce the need for EVPN or other solutions that rely on control plane learning to manage/reduce flooding. As another example, because the techniques eliminate shared VTEPs among tenants and isolate traffic on the basis of VTEP rather than merely VNIs, the techniques may increase service isolation among tenants hosted by a computing infrastructure as well as increase the number of VXLAN VNIs beyond the 24-bit VNI limit available for the computing infrastructure provider(s). The techniques may in fact enable overlapping VNI space among tenants, for tenant-specific VTEPs may each support the full 24-bit VNI space while still permitting traffic isolation. VXLANVXLAN

In one example, a computing device comprises a network interface controller (NIC); and processing circuitry having access to storage media encoded with instructions, the processing circuitry configured to receive, by a main packet processor, a packet from the NIC; send, by the main packet processor, based on a virtual extensible local area network (VXLAN) tunnel endpoint (VTEP) indicated by a packet, the packet to a tenant-specific packet processor associated with the VTEP; send, by the tenant-specific packet processor, at least a portion of the packet to a workload; and process, by the workload, the at least a portion of the packet.

In another example, a computing system comprises a first computing device configured with a first virtual extensible local area network (VXLAN) tunnel endpoint (VTEP) for a tenant, the first VTEP having an interface configured with a virtual network address; and a second computing device configured with a second virtual extensible local area network (VXLAN) tunnel endpoint (VTEP) for the tenant, the second VTEP having an interface configured with the virtual network address.

In another example, a method comprises receiving, by a main packet processor of a computing device, a packet from a network interface controller (NIC) of the computing device; sending, by the main packet processor, based on a virtual extensible local area network (VXLAN) tunnel endpoint (VTEP) indicated by a packet, the packet to a tenant-specific packet processor of the computing device, the tenant-specific packet processor associated with the VTEP; sending, by the tenant-specific packet processor, at least a portion of the packet to a workload of the computing device; and processing, by the workload, the at least a portion of the packet.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram that illustrates an example network system, according to techniques described herein.

FIG. 2 is a block diagram illustrating a high-level view of a data center that provides an operating environment for a cloud-based services exchange connecting multiple computing infrastructures, according to techniques described herein.

FIGS. 3A-3B are block diagrams illustrating an example network infrastructure and provisioning by a programmable network platform and controller, in accordance with techniques described in this disclosure.

FIGS. 4A-4B are a block diagrams illustrating example servers configured according to techniques of this disclosure.

FIG. 5 is a block diagram of an example computing device, according to techniques of this disclosure.

FIG. 6 is a flow diagram illustrating an example operation according to techniques of this disclosure.

Like reference characters denote like elements throughout the figures and text.

### DETAILED DESCRIPTION

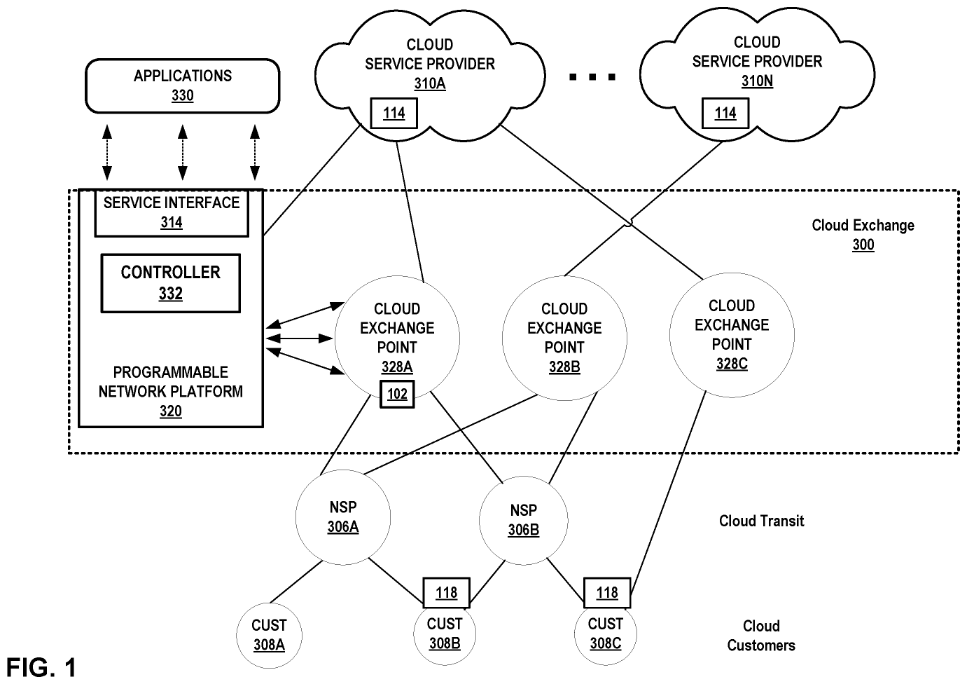

FIG. 1 illustrates a block diagram that illustrates an example network system, according to techniques described herein. The example network system of FIG. 1 depicts a possible network architecture in which techniques of this disclosure may be applied. However, the techniques are applicable to other computing infrastructure(s) and network systems that include such computing infrastructure(s).

The network system of FIG. 1 depicts a metro-based cloud exchange that provides multiple cloud exchange points. The multiple cloud exchange points may be used to implement, at least in part, a compute cluster 102. Each of cloud-based services exchange points 328A-328C (described hereinafter as “cloud exchange points” and collectively referred to as “cloud exchange points 328”) of cloud-based services exchange 300 (“cloud exchange 300”) may represent a different data center geographically located within the same metropolitan area (“metro-based,” e.g., in New York City, New York; Silicon Valley, California; Seattle-Tacoma, Washington; Minneapolis-St. Paul, Minnesota; London, UK; etc.) to provide resilient and independent cloud-based services exchange by which cloud-based services customers (“cloud customers”) and cloud-based service providers (“cloud providers”) connect to receive and provide, respectively, cloud services. In various examples, cloud exchange 300 may include more or fewer cloud exchange points 328. In some instances, a cloud exchange 300 includes just one cloud exchange point 328. As used herein, reference to a “cloud exchange” or “cloud-based services exchange” may refer to a cloud exchange point. A cloud exchange provider may deploy instances of cloud exchanges 300 in multiple different metropolitan areas, each instance of cloud exchange 300 having one or more cloud exchange points 328.

Each of cloud exchange points 328 includes network infrastructure and an operating environment by which cloud customers 308A-308C (collectively, “cloud customers 308”) receive cloud services from multiple cloud service providers 310A-310N (collectively, “cloud service providers 310”). Each of cloud service providers 310 may host one or more compute clusters 114. As noted above, the cloud service providers 310 may be public or private cloud service providers. Each of cloud service providers 310 may be a Software-as-a-Service (SaaS), Platform-aaS (PaaS), Infrastructure-aaS (IaaS), Virtualization-aaS (VaaS), and data Storage-aaS (dSaaS) provider. Each of cloud service providers 310 may represent a public cloud, such as AMAZON WEB SERVICES (AWS), GOOGLE CLOUD PLATFORM (GCP), or MICROSOFT AZURE.

Cloud exchange 300 provides customers of the exchange, e.g., enterprises, network carriers, network service providers, and SaaS customers, with secure, private, virtual connections to multiple cloud service providers (CSPs) globally. The multiple CSPs participate in the cloud exchange by virtue of their having at least one accessible port in the cloud exchange by which a customer may connect to the one or more cloud services offered by the CSPs, respectively. Cloud exchange 300 allows private networks of any customer to be directly cross-connected to any other customer at a common point, thereby allowing direct exchange of network traffic between the networks of the customers.

Cloud customers 308 may receive cloud-based services directly via a layer 3 peering and physical connection to one of cloud exchange points 328 or indirectly via one of network service providers 306A-306B (collectively, “NSPs 306,” or alternatively, “carriers 306”). Cloud customers 308 may include customers associated with a VNF 104 as described above. For example, cloud customers 308 may deploy compute clusters 118 that communicate with compute clusters 114 via cloud exchange 300 and, in some cases, NSPs 306.

Each of compute clusters 102, 118, 114 may include one or more compute nodes that implement physical or virtual computing devices (e.g., real or virtual servers) that execute workloads for applications or services. Workloads may include one or more virtual machines, containers, Kubernetes pods each including one or more containers, bare metal processes, and/or other types of workloads.

NSPs 306 provide “cloud transit” by maintaining a physical presence within one or more of cloud exchange points 328 and aggregating layer 3 access from one or customers 308. NSPs 306 may peer, at layer 3, directly with one or more cloud exchange points 328 and in so doing offer indirect layer 3 connectivity and peering to one or more customers 308 by which customers 308 may obtain cloud services from the cloud exchange 300. Each of cloud exchange points 328, in the example of FIG. 1, is assigned a different autonomous system number (ASN). For example, cloud exchange point 328A is assigned ASN 1, cloud exchange point 328B is assigned ASN 2, and so forth. Each cloud exchange point 328 is thus a next hop in a path vector routing protocol (e.g., BGP) path from cloud service providers 310 to customers 308. As a result, each cloud exchange point 328 may, despite not being a transit network having one or more wide area network links and concomitant Internet access and transit policies, peer with multiple different autonomous systems via external BGP (eBGP) or other exterior gateway routing protocol in order to exchange, aggregate, and route service traffic from one or more cloud service providers 310 to customers. In other words, cloud exchange points 328 may internalize the eBGP peering relationships that cloud service providers 310 and customers 308 would maintain on a pair-wise basis. Instead, a customer 308 may configure a single eBGP peering relationship with a cloud exchange point 328 and receive, via the cloud exchange, multiple cloud services from one or more cloud service providers 310. While described herein primarily with respect to eBGP or other layer 3 routing protocol peering between cloud exchange points and customer, NSP, or cloud service provider networks, the cloud exchange points may learn routes from these networks in other way, such as by static configuration, or via Routing Information Protocol (RIP), Open Shortest Path First (OSPF), Intermediate System-to-Intermediate System (IS-IS), or other route distribution protocol.

As examples of the above, customer 308C is illustrated as having contracted with a cloud exchange provider for cloud exchange 300 to directly access layer 3 cloud services via cloud exchange points 328C. In this way, customer 308C receives redundant layer 3 connectivity to cloud service provider 310A, for instance. Customer 308C, in contrast, is illustrated as having contracted with the cloud exchange provider for cloud exchange 300 to directly access layer 3 cloud services via cloud exchange point 328C and also to have contracted with NSP 306B to access layer 3 cloud services via a transit network of the NSP 306B. Customer 308B is illustrated as having contracted with multiple NSPs 306A, 306B to have redundant cloud access to cloud exchange points 328A, 328B via respective transit networks of the NSPs 306A, 306B. The contracts described above are instantiated in network infrastructure of the cloud exchange points 328 by L3 peering configurations within switching devices of NSPs 306 and cloud exchange points 328 and L3 connections, e.g., layer 3 virtual circuits, established within cloud exchange points 328 to interconnect cloud service provider 310 networks to NSPs 306 networks and customer 308 networks, all having at least one port offering connectivity within one or more of the cloud exchange points 328.

In some examples, cloud exchange 300 allows a corresponding one of customer customers 308A, 308B of any network service providers (NSPs) or “carriers” 306A-306B (collectively, “carriers 306”) or other cloud customers including customers 308C to be directly connected, via a virtual layer 2 (L2) or layer 3 (L3) connection to any other customer network and/or to any of CSPs 310, thereby allowing direct exchange of network traffic among the customer networks and CSPs 310. The virtual L2 or L3 connection may be referred to as a “virtual circuit.”

Carriers 306 may each represent a network service provider that is associated with a transit network by which network subscribers of the carrier 306 may access cloud services offered by CSPs 310 via the cloud exchange 300. In general, customers of CSPs 310 may include network carriers, large enterprises, managed service providers (MSPs), as well as Software-as-a-Service (SaaS), Platform-aaS (PaaS), Infrastructure-aaS (IaaS), Virtualization-aaS (VaaS), and data Storage-aaS (dSaaS) customers for such cloud-based services as are offered by the CSPs 310 via the cloud exchange 300.

In this way, cloud exchange 300 streamlines and simplifies the process of partnering CSPs 310 and customers (via carriers 306 or directly) in a transparent and neutral manner. One example application of cloud exchange 300 is a co-location and interconnection data center in which CSPs 310 and carriers 306 and/or customers 308 may already have network presence, such as by having one or more accessible ports available for interconnection within the data center, which may represent any of cloud exchange points 328. This allows the participating carriers, customers, and CSPs to have a wide range of interconnectivity options within the same facility. A carrier/customer may in this way have options to create many-to-many interconnections with only a one-time hook up to one or more cloud exchange points 328. In other words, instead of having to establish separate connections across transit networks to access different cloud service providers or different cloud services of one or more cloud service providers, cloud exchange 300 allows customers to interconnect to multiple CSPs and cloud services.

Cloud exchange 300 includes a programmable network platform 320 for dynamically programming cloud exchange 300 to responsively and assuredly fulfill service requests that encapsulate business requirements for services provided by cloud exchange 300 and/or cloud service providers 310 coupled to the cloud exchange 300. Programmable network platform 320 may include a controller 332 that configures and manages multiple Virtual Extensible LAN (VXLAN) Virtual Tunnel Endpoints (VTEPs) per compute node within a computing infrastructure, such as any one or more of compute clusters 102, 114, 118, according to techniques of this disclosure. For example, controller 332 may additionally organize, direct and integrate workloads, as well as other software and network sub-systems. While depicted as a component of programmable network platform 320, controller 332 may be a separate application. In some examples, controller 332 includes a workload orchestration system (e.g., a container or virtual machine orchestrator) that has been extended to configure and manage multiple VXLAN VTEPs per compute node.

The programmable network platform 320 enables the provider that administers the cloud exchange 300 to dynamically configure and manage the cloud exchange 300 to, for instance, facilitate virtual connections for cloud-based services delivery from multiple cloud service providers 310 to one or more cloud customers 308. The cloud exchange 300 may enable cloud customers 308 to bypass the public Internet to directly connect to cloud services providers 310 so as to improve performance, reduce costs, increase the security and privacy of the connections, and leverage cloud computing for additional applications. In this way, enterprises, network carriers, and SaaS customers, for instance, can at least in some aspects integrate cloud services with their internal applications as if such services are part of or otherwise directly coupled to their own data center network.

In other examples, programmable network platform 320 enables the cloud service provider to configure cloud exchange 300 with a L3 instance requested by a cloud customer 308, as described herein. A customer 308 may request an L3 instance to link multiple cloud service providers by the L3 instance, for example (e.g., for transferring the customer's data between two cloud service providers, or for obtaining a mesh of services from multiple cloud service providers).

Programmable network platform 320 may represent an application executing within one or more data centers of the cloud exchange 300 or alternatively, off-site at a back office or branch of the cloud provider (for instance). Programmable network platform 320 may be distributed in whole or in part among the data centers, each data center associated with a different cloud exchange point 328 to make up the cloud exchange 300. Although shown as administering a single cloud exchange 300, programmable network platform 320 may control service provisioning for multiple different cloud exchanges. Alternatively or additionally, multiple separate instances of the programmable network platform 320 may control service provisioning for respective multiple different cloud exchanges.

In the illustrated example, programmable network platform 320 includes a service interface (or “service API”) 314 that defines the methods, fields, and/or other software primitives by which applications 330, such as a customer portal, may invoke the programmable network platform 320. The service interface 314 may allow carriers 306, customers 308, cloud service providers 310, and/or the cloud exchange provider programmable access to capabilities and assets of the cloud exchange 300 according to techniques described herein.

For example, the service interface 314 may facilitate machine-to-machine communication to enable dynamic provisioning of virtual circuits in the cloud exchange for interconnecting customer and/or cloud service provider networks. In this way, the programmable network platform 320 enables the automation of aspects of cloud services provisioning. For example, the service interface 314 may provide an automated and seamless way for customers to establish, de-install and manage interconnections among multiple, different cloud providers participating in the cloud exchange.

Further example details of a cloud-based services exchange can be found in U.S. patent application Ser. No. 15/099,407, filed Apr. 14, 2016 and entitled “CLOUD-BASED SERVICES EXCHANGE;” U.S. patent application Ser. No. 14/927,451, filed Oct. 29, 2015 and entitled “INTERCONNECTION PLATFORM FOR REAL-TIME CONFIGURATION AND MANAGEMENT OF A CLOUD-BASED SERVICES EXCHANGE;” and U.S. patent application Ser. No. 14/927,306, filed Oct. 29, 2015 and entitled “ORCHESTRATION ENGINE FOR REAL-TIME CONFIGURATION AND MANAGEMENT OF INTERCONNECTIONS WITHIN A CLOUD-BASED SERVICES EXCHANGE;” each of which are incorporated herein by reference in their respective entireties.

Controller 332 may include an interface (not shown) by which a user can request and configure a tenant within any one or more of compute clusters 102, 114, or 118. Configuring a tenant may include assigning a VTEP (more specifically, a VTEP network address) for the tenant, configuring compute nodes with a separate namespace for the tenant in which data plane resources (e.g., workloads) for the tenant may execute along with a tenant-specific packet processor, configuring a flood list for BUM traffic that is specific to the tenant network presence, and configuring packet processing chaining within a compute node between a main packet processor and the tenant-specific packet processor for the tenant.

By using tenant-specific VTEPs within computing devices of compute clusters 102, 114, or 118, rather than solely relying on the VNIs for implementing multi-tenancy, Controller 332 may facilitate reducing a size of the flood list(s) and reduce the amount of flooding of BUM traffic across compute/metro/regions hosting distributed tenant workloads, such as between compute cluster 118 of customer 308B and computer cluster 114 of cloud service provider 310A. Because the techniques eliminate shared VTEPs among tenants and isolate traffic on the basis of VTEP and VTEP network address rather than merely VNIs, Controller 332 may also increase service isolation among tenants hosted by any of compute clusters 102, 114, or 118, as well as increase the number of VXLAN VNIs beyond the 24-bit VNI limit available for the computing infrastructure provider(s) (CSPs 310, customers 308, or the cloud exchange 300 provider in the example of FIG. 1).

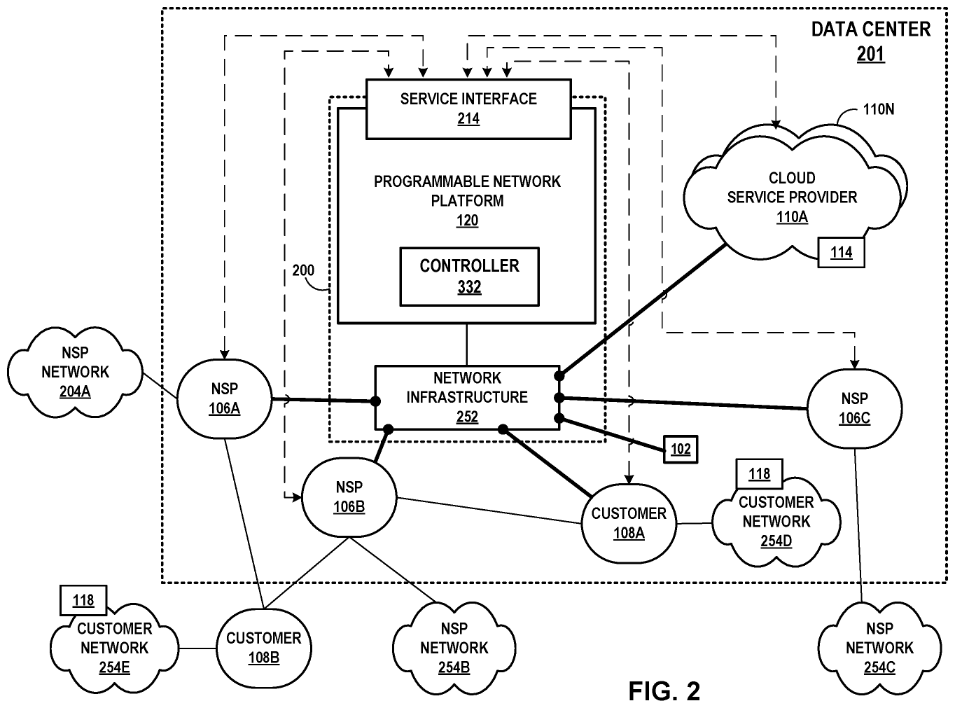

FIG. 2 is a block diagram illustrating a high-level view of a data center 201 that provides an operating environment for a cloud-based services exchange connecting multiple computing infrastructures, according to techniques described herein. Cloud-based services exchange 200 (“cloud exchange 200”) allows a corresponding one of customer networks 204D, 204E and NSP networks 204A-204C (collectively, “‘private’ or ‘carrier’ networks 204”) of any NSPs 106A-106C or other cloud customers including customers 108A, 108B to be directly connected, via a layer 3 (L3) or layer 2 (L2) connection to any other customer network and/or to any of cloud service providers 110A-110N, thereby allowing exchange of cloud service traffic among the customer networks and/or CSPs 110. Data center 201 may be entirely located within a centralized area, such as a warehouse or localized data center complex, and provide power, cabling, security, and other services to NSPs, customers, and cloud service providers that locate their respective networks within the data center 201 (e.g., for co-location) and/or connect to the data center 201 by one or more external links.

Network service providers 106 may each represent a network service provider that is associated with a transit network by which network subscribers of the NSP 106 may access cloud services offered by CSPs 110 via the cloud exchange 200. In general, customers of CSPs 110 may include network carriers, large enterprises, managed service providers (MSPs), as well as Software-as-a-Service (SaaS), Platform-aaS (PaaS), Infrastructure-aaS (IaaS), Virtualization-aaS (VaaS), and data Storage-aaS (dSaaS) customers for such cloud-based services as are offered by the CSPs 110 via the cloud exchange 200.

In this way, cloud exchange 200 streamlines and simplifies the process of partnering CSPs 110 and customers 108 (indirectly via NSPs 106 or directly) in a transparent and neutral manner. One example application of cloud exchange 200 is a co-location and interconnection data center in which CSPs 110, NSPs 106 and/or customers 108 may already have network presence, such as by having one or more accessible ports available for interconnection within the data center. This allows the participating carriers, customers, and CSPs to have a wide range of interconnectivity options in the same facility.

Cloud exchange 200 of data center 201 includes network infrastructure 222 that provides a L2/L3 switching fabric by which CSPs 110 and customers/NSPs interconnect. This enables an NSP/customer to have options to create many-to-many interconnections with only a one-time hook up to the switching network and underlying network infrastructure 222 that presents an interconnection platform for cloud exchange 200. In other words, instead of having to establish separate connections across transit networks to access different cloud service providers or different cloud services of one or more cloud service providers, cloud exchange 200 allows customers to interconnect to multiple CSPs and cloud services using network infrastructure 222 within data center 201, which may represent any of the edge networks described in this disclosure, at least in part.

By using cloud exchange 200, customers can purchase services and reach out to many end users in many different geographical areas without incurring the same expenses typically associated with installing and maintaining multiple virtual connections with multiple CSPs 110. For example, NSP 106A can expand its services using network 204B of NSP 106B. By connecting to cloud exchange 200, a NSP 106 may be able to generate additional revenue by offering to sell its network services to the other carriers. For example, NSP 106C can offer the opportunity to use NSP network 204C to the other NSPs.

Cloud exchange 200 includes a programmable network platform 120 that exposes at least one service interface, which may include in some examples and are alternatively referred to herein as application programming interfaces (APIs) in that the APIs define the methods, fields, and/or other software primitives by which applications may invoke the programmable network platform 120. The software interfaces allow NSPs 206 and customers 108 programmable access to capabilities and assets of the cloud exchange 200. The programmable network platform 120 may alternatively be referred to as a controller, provisioning platform, provisioning system, service orchestration system, etc., for establishing end-to-end services including, e.g., connectivity between customers and cloud service providers according to techniques described herein.

On the buyer side, the software interfaces presented by the underlying interconnect platform provide an extensible framework that allows software developers associated with the customers of cloud exchange 200 (e.g., customers 108 and NSPs 206) to create software applications that allow and leverage access to the programmable network platform 120 by which the applications may request that the cloud exchange 200 establish connectivity between the customer and cloud services offered by any of the CSPs 110. For example, these buyer-side software interfaces may allow customer applications for NSPs and enterprise customers, e.g., to obtain authorization to access the cloud exchange, obtain information regarding available cloud services, obtain active ports and metro area details for the customer, create virtual circuits of varying bandwidth to access cloud services, including dynamic selection of bandwidth based on a purchased cloud service to create on-demand and need based virtual circuits to or between cloud service providers, delete virtual circuits, obtain active virtual circuit information, obtain details surrounding CSPs partnered with the cloud exchange provider, obtain customized analytics data, validate partner access to interconnection assets, and assure service delivery.

On the cloud service provider seller side, the software interfaces may allow software developers associated with cloud providers to manage their cloud services and to enable customers to connect to their cloud services. For example, these seller-side software interfaces may allow cloud service provider applications to obtain authorization to access the cloud exchange, obtain information regarding available cloud services, obtain active ports and metro area details for the provider, obtain active port details in a given data center for the provider, approve or reject virtual circuits of varying bandwidth created by customers for the purpose of accessing cloud services, obtain virtual circuits pending addition and confirm addition of virtual circuits, obtain virtual circuits pending deletion and confirm deletion of virtual circuits, obtain customized analytics data, validate partner access to interconnection assets, and assure service delivery.

Service interface 214 facilitates machine-to-machine communication to enable dynamic service provisioning and service delivery assurance. In this way, the programmable network platform 120 enables the automation of aspects of cloud services provisioning. For example, the software interfaces may provide an automated and seamless way for customers to establish, de-install and manage interconnection with or between multiple, different cloud providers participating in the cloud exchange. The programmable network platform 120 may in various examples execute on one or virtual machines and/or real servers of data center 201, or off-site. Service interface 214 may include one or more interface methods by which a user or system can configure any of compute clusters 102, 114, or 118 with tenant-specific VTEPs, as described in this disclosure.

In the example of FIG. 2, network infrastructure 222 represents the cloud exchange switching fabric and includes multiple ports that may be dynamically interconnected with virtual circuits by, e.g., invoking service interface 214 of the programmable network platform 120. Each of the ports is associated with one of carriers 106, customers 108, and CSPs 110.

In some examples, a cloud exchange seller (e.g., an enterprise or a CSP nested in a CSP) may request and obtain an L3 instance, and may then create a seller profile associated with the L3 instance, and subsequently operate as a seller on the cloud exchange. The techniques of this disclosure enable multiple CSPs to participate in an Enterprise's L3instance (e.g., an L3 “routed instance” or L2 “bridged instance”) without each CSP flow being anchored with an enterprise device.

In some aspects, the programmable network platform may provision a cloud exchange to deliver services made up of multiple constituent services provided by multiple different cloud service providers, where this is provided via the L3 instance as a service described herein. Each of these constituent services is referred to herein as a “micro-service” in that it is part of an overall service applied to service traffic. That is, a plurality of micro-services may be applied to service traffic in a particular “arrangement,” “ordering,” or “topology,” in order to make up an overall service for the service traffic. The micro-services themselves may be applied or offered by the cloud service providers 110.

Controller 332 may leverage IP connectivity facilitated by programmable network platform 120 configuring network infrastructure 252 to operate as an “IP core” enabling connectivity among workloads for a distributed architecture for a tenant, the workloads variously located in any combination of one or more of compute clusters 102, 114, or 118. Controller 332 may enable multiple VTEPs per compute node, with tenant-specific VTEPs configured in compute nodes that host such workloads, according to techniques described in this disclosure.

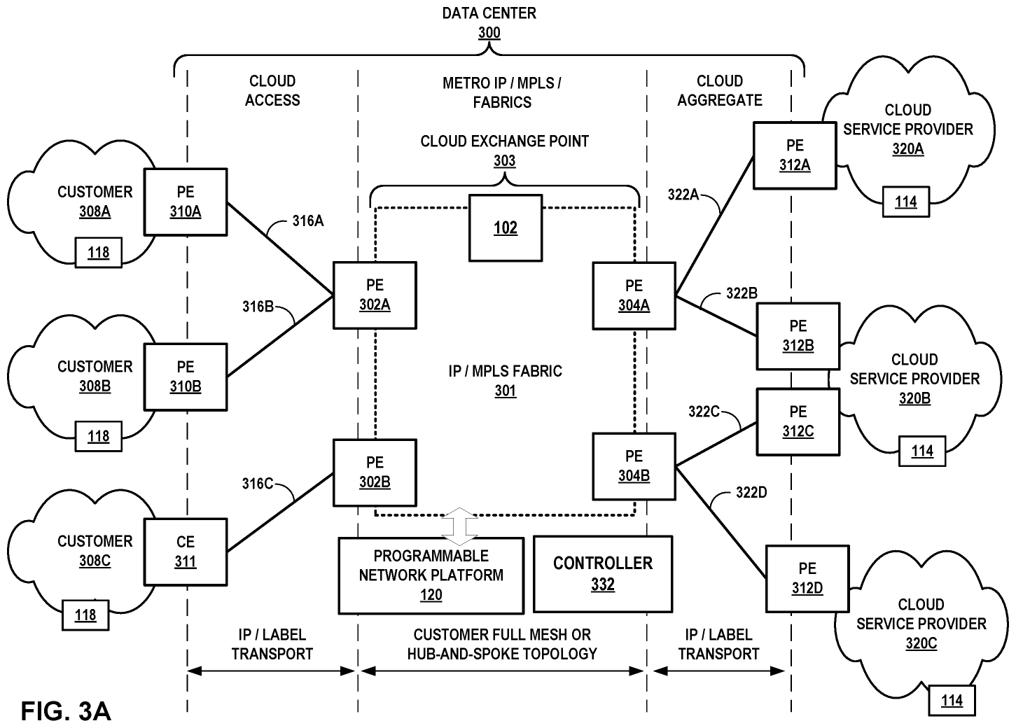

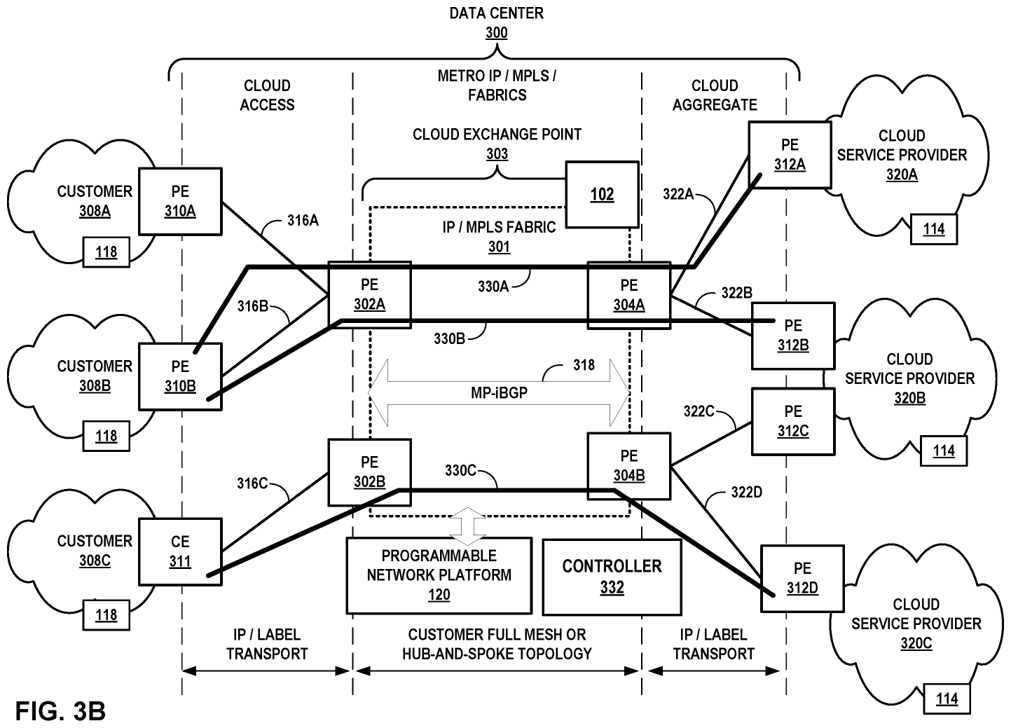

FIGS. 3A-3B are block diagrams illustrating an example network infrastructure and provisioning by a programmable network platform and controller, in accordance with techniques described in this disclosure. FIGS. 3A-3B illustrate example network infrastructure and service provisioning by a programmable network platform for a cloud exchange that aggregates the cloud services of multiple cloud service providers for provisioning to customers of the cloud exchange provider and aggregates access for multiple customers to one or more cloud service providers. In this example, customer networks 308A-308C (collectively, “customer networks 308”), each associated with a different customer, access a cloud exchange point within a data center 300 in order receive aggregated cloud services from one or more cloud service provider networks 320, each associated with a different cloud service provider 110. In some examples, customer networks 308 each include endpoint devices that consume cloud services provided by cloud service provider network 320. Example endpoint devices include servers, smart phones, television set-top boxes, workstations, laptop/tablet computers, video gaming systems, teleconferencing systems, media players, and so forth.

Customer networks 308A-308B include respective provider edge/autonomous system border routers (PE/ASBRs) 310A-310B. Each of PE/ASBRs 310A, 310B may execute exterior gateway routing protocols to peer with one of PE routers 302A-302B (“PE routers 302” or more simply “PEs 302”) over one of access links 316A-316B (collectively, “access links 316”). In the illustrated examples, each of access links 316 represents a transit link between an edge router of a customer network 308 and an edge router (or autonomous system border router) of cloud exchange point 303. For example, PE 310A and PE 302A may directly peer via an exterior gateway protocol, e.g., exterior BGP, to exchange L3 routes over access link 316A and to exchange L3 data traffic between customer network 308A and cloud service provider networks 320. Access links 316 may in some cases represent and alternatively be referred to as attachment circuits for IP-VPNs configured in IP/MPLS fabric 301, as described in further detail below. Access links 316 may in some cases each include a direct physical connection between at least one port of a customer network 308 and at least one port of cloud exchange point 303, with no intervening transit network. Access links 316 may operate over a VLAN or a stacked VLAN (e.g. QinQ), a VXLAN, an LSP, a GRE tunnel, or other type of tunnel.

While illustrated and primarily described with respect to L3 connectivity, PE routers 302 may additionally offer, via access links 316, L2 connectivity between customer networks 308 and cloud service provider networks 320. For example, a port of PE router 302A may be configured with an L2 interface that provides, to customer network 308A, L2 connectivity to cloud service provider 320A via access link 316A, with the cloud service provider 320A router 312A coupled to a port of PE router 304A that is also configured with an L2 interface. The port of PE router 302A may be additionally configured with an L3 interface that provides, to customer network 308A, L3 connectivity to cloud service provider 320B via access links 316A. PE 302A may be configured with multiple L2 and/or L3 sub-interfaces such that customer 308A may be provided, by the cloud exchange provider, with a one-to-many connection to multiple cloud service providers 320.

To create an L2 interconnection between a customer network 308 and a cloud service provider network 320, in some examples, IP/MPLS fabric 301 is configured with an L2 bridge domain (e.g., an L2 virtual private network (L2VPN) such as a virtual private LAN service (VPLS), E-LINE, or E-LAN) to bridge L2 traffic between a customer-facing port of PEs 302 and a CSP-facing port of cloud service providers 320. In some cases, a cloud service provider 320 and customer 308 may have access links to the same PE router 302, 304, which bridges the L2 traffic using the bridge domain.

To create an L3 interconnection between a customer network 308 and a cloud service provider network 320, in some examples, IP/MPLS fabric 301 is configured with L3 virtual routing and forwarding instances (VRFs). In some cases, IP/MPLS fabric 301 may be configured with an L3 instance that includes one or more VRFs, and the L3 instance may link multiple cloud service provider networks 320. In this case, a customer network 308 may not need to be interconnected or have any physical presence in the cloud exchange or data center.

Each of access links 316 and aggregation links 322 may include a network interface device (NID) that connects customer network 308 or cloud service provider 328 to a network link between the NID and one of PE routers 302, 304. Each of access links 316 and aggregation links 322 may represent or include any of a number of different types of links that provide L2 and/or L3 connectivity.

In this example, customer network 308C is not an autonomous system having an autonomous system number. Customer network 308C may represent an enterprise, network service provider, or other customer network that is within the routing footprint of the cloud exchange point. Customer network includes a customer edge (CE) device 311 that may execute exterior gateway routing protocols to peer with PE router 302B over access link 316C. In various examples, any of PEs 310A-310B may alternatively be or otherwise represent CE devices.

Access links 316 include physical links. PE/ASBRs 310A-310B, CE device 311, and PE routers 302A-302B exchange L2/L3 packets via access links 316. In this respect, access links 316 constitute transport links for cloud access via cloud exchange point 303. Cloud exchange point 303 may represent an example of any of cloud exchange points 128. Data center 300 may represent an example of data center 201.

Cloud exchange point 303, in some examples, aggregates customers 308 access to the cloud exchange point 303 and thence to any one or more cloud service providers 320. FIGS. 3A-3B, e.g., illustrate access links 316A-316B connecting respective customer networks 308A-308B to PE router 302A of cloud exchange point 303 and access link 316C connecting customer network 308C to PE router 302B. Any one or more of PE routers 302, 304 may comprise ASBRs. PE routers 302, 304 and IP/MPLS fabric 301 may be configured according to techniques described herein to interconnect any of access links 316 to any of cloud aggregation links 322. As a result, cloud service provider network 320A, e.g., needs only to have configured a single cloud aggregate link (here, access link 322A) in order to provide services to multiple customer networks 308. That is, the cloud service provider operating cloud service provider network 302A does not need to provision and configure separate service links from cloud service provider network 302A to each of PE routers 310, 311, for instance, in order to provide services to each of customer network 308. Cloud exchange point 303 may instead connect cloud aggregation link 322A and PE 312A of cloud service provider network 320A to multiple cloud access links 316 to provide layer 3 peering and network reachability for the cloud services delivery.

In addition, a single customer network, e.g., customer network 308A, need only to have configured a single cloud access link (here, access link 316A) to the cloud exchange point 303 within data center 300 in order to obtain services from multiple cloud service provider networks 320 offering cloud services via the cloud exchange point 303. That is, the customer or network service provider operating customer network 308A does not need to provision and configure separate service links connecting customer network 308A to different PE routers 312, for instance, in order to obtain services from multiple cloud service provider networks 320. Cloud exchange point 303 may instead connect cloud access link 316A (again, as one example) to multiple cloud aggregate links 322 to provide layer 3 peering and network reachability for the cloud services delivery to customer network 308A.

Cloud service provider networks 320 each includes servers configured to provide one or more cloud services to users. These services may be categorized according to service types, which may include for examples, applications/software, platforms, infrastructure, virtualization, and servers and data storage. Example cloud services may include content/media delivery, cloud-based storage, cloud computing, online gaming, IT services, etc.

Cloud service provider networks 320 include PE routers 312A-312D that each executes an exterior gateway routing protocol, e.g., eBGP, to exchange routes with PE routers 304A-304B (collectively, “PE routers 304”) of cloud exchange point 303. Each of cloud service provider networks 320 may represent a public, private, or hybrid cloud. Each of cloud service provider networks 320 may have an assigned autonomous system number or be part of the autonomous system footprint of cloud exchange point 303.

In the illustrated example, an Internet Protocol/Multiprotocol label switching (IP/MPLS) fabric 301 interconnects PEs 302 and PEs 304. IP/MPLS fabric 301 include one or more switching and routing devices, including PEs 302, 304, that provide IP/MPLS switching and routing of IP packets to form an IP backbone. In some example, IP/MPLS fabric 301 may implement one or more different tunneling protocols (i.e., other than MPLS) to route traffic among PE routers and/or associate the traffic with different IP-VPNs. In accordance with techniques described herein, IP/MPLS fabric 301 implement IP virtual private networks (IP-VPNs) to connect any of customers 308 with multiple cloud service provider networks 320 to provide a data center-based ‘transport’ and layer 3 connection.

Whereas service provider-based IP backbone networks require wide-area network (WAN) connections with limited bandwidth to transport service traffic from layer 3 services providers to customers, the cloud exchange point 303 as described herein ‘transports’ service traffic and connects cloud service providers 320 to customers 308 within the high-bandwidth local environment of data center 300 provided by a data center-based IP/MPLS fabric 301. In some example configurations, a customer network 308 and cloud service provider network 320 may connect via respective links to the same PE router of IP/MPLS fabric 301.

Access links 316 and aggregation links 322 may include attachment circuits that associate traffic, exchanged with the connected customer network 308 or cloud service provider network 320, with virtual routing and forwarding instances (VRFs) configured in PEs 302, 304 and corresponding to IP-VPNs operating over IP/MPLS fabric 301. For example, PE 302A may exchange IP packets with PE 310A on a bidirectional label-switched path (LSP) operating over access link 316A, the LSP being an attachment circuit for a VRF configured in PE 302A. As another example, PE 304A may exchange IP packets with PE 312A on a bidirectional label-switched path (LSP) operating over access link 322A, the LSP being an attachment circuit for a VRF configured in PE 304A. Each VRF may include or represent a different routing and forwarding table with distinct routes.

PE routers 302, 304 of IP/MPLS fabric 301 may be configured in respective hub-and-spoke arrangements for cloud services, with PEs 304 implementing cloud service hubs and PEs 302 being configured as spokes of the hubs (for various hub-and-spoke instances/arrangements). A hub-and-spoke arrangement ensures that service traffic is enabled to flow between a hub PE and any of the spoke PEs, but not directly between different spoke PEs. As described further below, in a hub-and-spoke arrangement for data center-based IP/MPLS fabric 301 and for southbound service traffic (i.e., from a CSP to a customer) PEs 302 advertise routes, received from PEs 310, to PEs 304, which advertise the routes to PEs 312. For northbound service traffic (i.e., from a customer to a CSP), PEs 304 advertise routes, received from PEs 312, to PEs 302, which advertise the routes to PEs 310.

For some customers of cloud exchange point 303, the cloud exchange point 303 provider may configure a full mesh arrangement whereby a set of PEs 302, 304 each couple to a different customer site network for the customer. In such cases, the IP/MPLS fabric 301 implements a layer 3 VPN (L3VPN) for cage-to-cage or redundancy traffic (also known as east-west or horizontal traffic). The L3VPN may effectuate a closed user group whereby each customer site network can send traffic to one another but cannot send or receive traffic outside of the L3VPN.

PE routers may couple to one another according to a peer model without use of overlay networks. That is, PEs 310 and PEs 312 may not peer directly with one another to exchange routes, but rather indirectly exchange routes via IP/MPLS fabric 301. In the example of FIG. 3B, cloud exchange point 303 is configured to implement multiple layer 3 virtual circuits 330A-330C (collectively, “virtual circuits 330”) to interconnect customer network 308 and cloud service provider networks 322 with end-to-end IP paths. Each of cloud service providers 320 and customers 308 may be an endpoint for multiple virtual circuits 330, with multiple virtual circuits 330 traversing one or more attachment circuits between a PE/PE or PE/CE pair for the IP/MPLS fabric 301 and the CSP/customer. A virtual circuit 330 represents a layer 3 path through IP/MPLS fabric 301 between an attachment circuit connecting a customer network to the fabric 301 and an attachment circuit connecting a cloud service provider network to the fabric 301. Each virtual circuit 330 may include at least one tunnel (e.g., an LSP and/or Generic Route Encapsulation (GRE) tunnel) having endpoints at PEs 302, 304. PEs 302, 304 may establish a full mesh of tunnels interconnecting one another.

Each virtual circuit 330 may include a different hub-and-spoke network configured in IP/MPLS network 301 having PE routers 302, 304 exchanging routes using a full or partial mesh of border gateway protocol peering sessions, in this example a full mesh of Multiprotocol Interior Border Gateway Protocol (MP-iBGP) peering sessions. MP-iBGP or simply MP-BGP is an example of a protocol by which routers exchange labeled routes to implement MPLS-based VPNs. However, PEs 302, 304 may exchange routes to implement IP-VPNs using other techniques and/or protocols.

In the example of virtual circuit 330A, PE router 312A of cloud service provider network 320A may send a route for cloud service provider network 320A to PE 304A via a routing protocol (e.g., cBGP) peering connection with PE 304A. PE 304A associates the route with a hub-and-spoke network, which may have an associated VRF, that includes spoke PE router 302A. PE 304A then exports the route to PE router 302A; PE router 304A may export the route specifying PE router 304A as the next hop router, along with a label identifying the hub-and-spoke network. PE router 302A sends the route to PE router 310B via a routing protocol connection with PE 310B. PE router 302A may send the route after adding an autonomous system number of the cloud exchange point 303 (e.g., to a BGP autonomous system path (AS_PATH) attribute) and specifying PE router 302A as the next hop router. Cloud exchange point 303 is thus an autonomous system “hop” in the path of the autonomous systems from customers 308 to cloud service providers 320 (and vice-versa), even though the cloud exchange point 303 may be based within a data center. PE router 310B installs the route to a routing database, such as a BGP routing information base (RIB) to provide layer 3 reachability to cloud service provider network 320A. In this way, cloud exchange point 303 “leaks” routes from cloud service provider networks 320 to customer networks 308, without cloud service provider networks 320 to customer networks 308 requiring a direct layer peering connection.

PE routers 310B, 302A, 304A, and 312A may perform a similar operation in the reverse direction to forward routes originated by customer network 308B to PE 312A and thus provide connectivity from cloud service provider network 320A to customer network 308B. In the example of virtual circuit 330B, PE routers 312B, 304A, 302A, and 310B exchange routes for customer network 308B and cloud service provider 320B in a manner similar to that described above for establishing virtual circuit 330B. As a result, cloud exchange point 303 within data center 300 internalizes the peering connections that would otherwise be established between PE 310B and each of PEs 312A, 312B so as to perform cloud aggregation for multiple layer 3 cloud services provided by different cloud service provider networks 320A, 320B and deliver the multiple, aggregated layer 3 cloud services to a customer network 308B having a single access link 316B to the cloud exchange point 303.

Absent the techniques described herein, fully interconnecting customer networks 308 and cloud service provider networks 320 would require 3×3 peering connections between each of PEs 310 and at least one of PEs 312 for each of cloud service provider networks 320. For instance, PE 310A would require a layer 3 peering connection with each of PEs 312. With the techniques described herein, cloud exchange point 303 may fully interconnect customer networks 308 and cloud service provider networks 320 with one peering connection per site PE (i.e., for each of PEs 310 and PEs 312) by internalizing the layer 3 peering and providing data center-based ‘transport’ between cloud access and cloud aggregate interfaces.

In examples in which IP/MPLS fabric 301 implements BGP/MPLS IP VPNs or other IP-VPNs that use route targets to control route distribution within the IP backbone, PEs 304 may be configured to import routes from PEs 302 and to export routes received from PEs 312, using different asymmetric route targets. Likewise, PEs 302 may be configured to import routes from PEs 304 and to export routes received from PEs 310 using the asymmetric route targets. Thus, PEs 302, 304 may configured to implement advanced L3VPNs that each includes a basic backbone L3VPN of IP/MPLS fabric 301 together with extranets of any of customer networks 308 and any of cloud service provider networks 320 attached to the basic backbone L3VPN.

Each advanced L3VPN constitutes a cloud service delivery network from a cloud service provider network 320 to one or more customer networks 308, and vice-versa. In this way, cloud exchange point 303 enables any cloud service provider network 320 to exchange cloud service traffic with any customer network 308 while internalizing the layer 3 routing protocol peering connections that would otherwise be established between pairs of customer networks 308 and cloud service provider networks 320 for any cloud service connection between a given pair. In other words, the cloud exchange point 303 allows each of customer networks 308 and cloud service provider networks 320 to establish a single (or more for redundancy or other reasons) layer 3 routing protocol peering connection to the data center-based layer 3 connect. By filtering routes from cloud service provider networks 320 to customer networks 308, and vice-versa, PEs 302, 304 thereby control the establishment of virtual circuits 330 and the flow of associated cloud service traffic between customer networks 308 and cloud service provider networks 320 within a data center 300. Routes distributed into MP-iBGP mesh 318 may be VPN-IPv4 routes and be associated with route distinguishers to distinguish routes from different sites having overlapping address spaces.

Programmable network platform 120 may receive service requests for creating. reading, updating, and/or deleting end-to-end services of the cloud exchange point 303. In response, programmable network platform 120 may configure PEs 302, 304 and/or other network infrastructure of IP/MPLS fabric 301 to provision or obtain performance or other operations information regarding the service. Operations for provisioning a service and performed by programmable network platform 120 may include configuring or updating VRFs, installing SDN forwarding information, configuring LSPs or other tunnels, configuring BGP, configuring access links 316 and aggregation links 322, or otherwise modifying the configuration of the IP/MPLS fabric 301.

Controller 332 may leverage IP connectivity facilitated by programmable network platform 120 configuring network infrastructure 252 to operate as an “IP core” enabling connectivity among workloads for a distributed architecture for a tenant, the workloads variously located in any combination of one or more of compute clusters 102, 114, or 118. Controller 332 may enable multiple VTEPs per compute node, with tenant-specific VTEPs configured in compute nodes that host such workloads, according to techniques described in this disclosure.

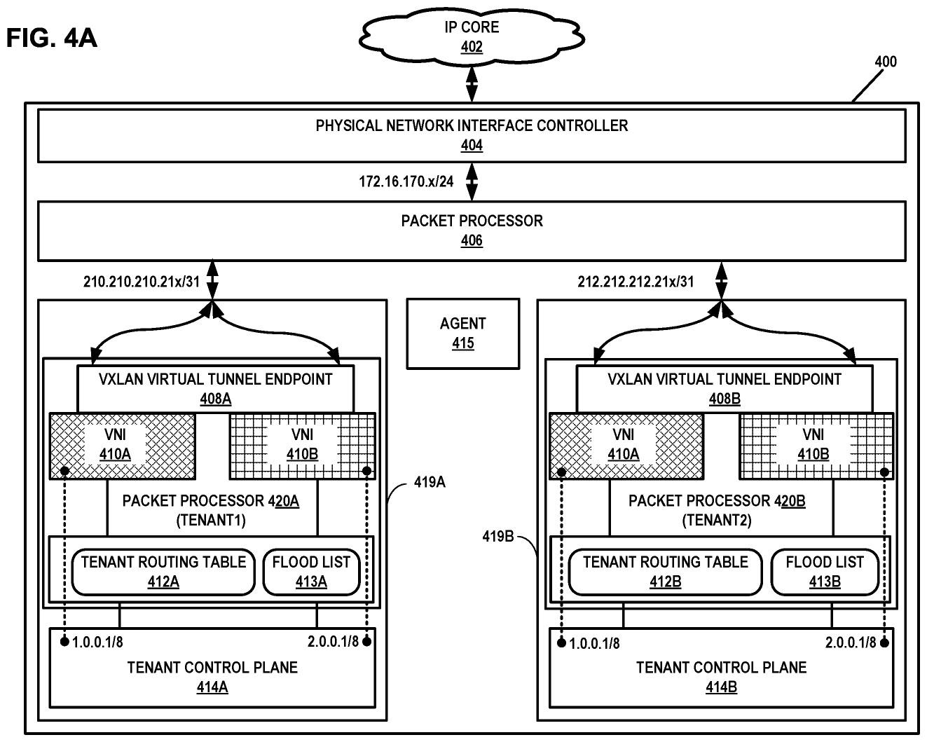

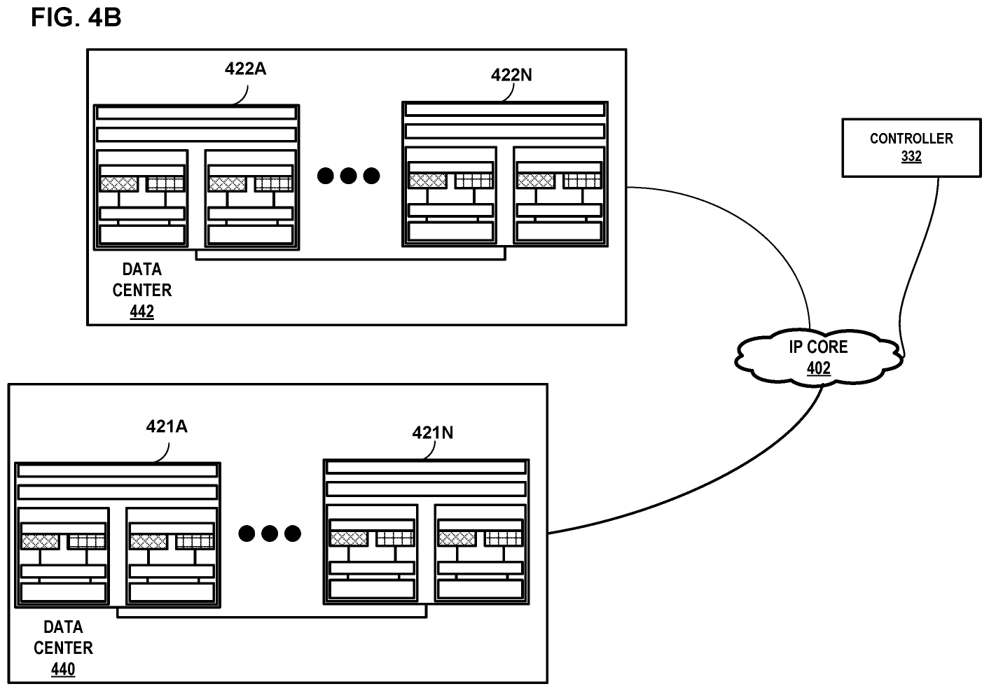

FIGS. 4A-4B are block diagrams illustrating example servers configured according to the techniques of this disclosure. FIG. 4A illustrates a single example server and a portion of the components of the example server, while FIG. 4B illustrates an example configuration of multiple servers that may each be configured similar to the server illustrated in FIG. 4A.

FIG. 4A is a block diagram illustrating an example server configured according to techniques of this disclosure. Server 400 includes physical network interface controller 404 (“NIC 404”) and is configured with main packet processor 406, tenant-specific packet processors 420A-420B (collectively, “tenant-specific packet processors 420”) having respective tenant routing tables 412A-412B (collectively, “tenant routing tables 412”), VTEPs 408A-408B (collectively, “VTEPs 408”), and tenant control planes 414A-414B (collectively, “tenant control planes 414”).

Server 400 is an example instance of a compute node, as described elsewhere in this document. For example, server 400 may be a compute node of any of compute cluster 102, 114, or 118.

Server 400 executes tenant control planes 414A-414B (collectively, “tenant control planes 414”). Each of tenant control planes 414 is an isolated control plane for a different tenant. A tenant may correspond to an organization, a sub-organization, an application, or other entity that can be provided traffic and control plane isolation, at least in some cases in a single operating system of server 400, in accordance with techniques of this disclosure.

Tenant control planes 814 may each implement a control plane for the corresponding tenant, and the control plane may manage the routing of packet flows. Tenant control planes 414 may each execute a routing protocol process that executes one more routing protocols, such as Border Gateway Protocol (BGP) or an interior gateway protocol (IGP), to exchange routing information with other routers and control planes. The routing information may be used to facilitate cloud-to-cloud connectivity between compute clusters operating on different private, public, or hybrid clouds. Each of tenant control planes 414 may execute one or more workloads to implement the control plane. In addition to or alternatively to routing protocol processes, control planes 414 may execute other network services such as load balancers, gateways, firewalls, network address translation devices, etc.

Packet processors 420 may operate in respective kernel namespaces 419A-419B (collectively, “namespaces 419”). Namespaces 419 may be Linux namespaces, for instance, where the operating system of server 400 is Linux; however, in other examples, namespaces 419 may be another type of namespace implemented by another type of operating system of server 400. Namespaces 419 partition kernel resources such that one set of processes sees one set of resources while another set of processes sees a different set of resources. Once traffic has been processed and directed to the appropriate one of tenant-specific packet processors 420, based on the VTEP network address indicated in the traffic, the techniques leveraging namespaces 419 may further facilitate traffic isolation between respective tenants associated with namespaces 419. Although illustrated as operating in kernel namespaces, tenant control planes 414 may execute in the user plane of server 400.

Agent 415 executes on server 400 to communicate with controller 332 to receive configuration data for configuring server 400. Configuration data may include configuration data for configuring namespaces 419 including VTEPs 408, VNIs 410, and packet processors 420 including tenant routing tables 412 and flood list 413, as well as for configuring main packet processor 406. Agent 415 may implement gRPC APIs, Netconf, REST APIs, a command-line interface, a graphical user interface, or other interface and/or protocol to receive the configuration data from controller 332. Agent 415 may communicate with controller 332 on a dedicated VXLAN or management interface in some examples.

IP core 402 may be the internet or may include or represent any public or private communications network or other network. For instance, IP core 402 may be or include a cellular, Wi-Fi®, satellite, enterprise, service provider, data center fabric, and/or other type of network enabling transfer of data between computing systems, servers, computing devices, and/or storage devices. One or more of such devices may transmit and receive data, commands, control signals, and/or other information across IP core 402 using any suitable communication techniques. IP core 402 may include one or more network hubs, network switches, network routers, satellite dishes, or any other network equipment. Such network devices or components may be operatively inter-coupled, thereby providing for the exchange of information between computers, devices, or other components (e.g., between one or more client devices or systems and one or more computer/server/storage devices or systems). IP core 402 connects server 400 to other servers and systems.

NIC 404 may receive data, such as BGP messages, via one or more ports. For example, NIC 404 may receive a packet that includes a VXLAN header. NIC 404, responsive to receiving a packet, may provide the packet to main packet processor 406.

In some examples, server 400 may use Data Plane Development Kit (DPDK) for internal packet forwarding and processing. Server 400 may instantiate instances of tenant-specific packet processors 420 on an as-needed basis. For example, server 400 may instantiate a new instance of packet processor 420 for a new tenant of server 400. Server 400 may allocate resources to packet processor 420 instances to conserve power consumption and resource usage.

Server 400 may use the multiple instances of packet processors 420 to accelerate migration and disaster recovery. For example, because each tenant is associated with one instance of packet processors 420, the failure of that instance on server only requires migration of the corresponding tenant. In other words, failures are local to tenant-specific packet processors 420, in contrast to the prior design in which all the tenants in a multi-tenant implementation operating on a compute node are brought down if even a single tenant configuration push caused an issue.

As directed by controller 332 providing configuration data and/or commands via agent 415, server 400 may instantiate packet processors 420 with particular resource and feature enhancements that are localized to individual packet processors 420. In an example, server 400 receives a request for a tenant that includes a requirement for a particular packet processor plugin. Server 400 may instantiate an instance of packet processors 420 that includes the plugin. In another example, server 400 receives a request for a packet processor 420 to include the particular packet processor plugin. Server 400 responsively updates to include the particular packet processor plugin. Server 400 may modify one of packet processors 420 without modifying other packet processors 420. Server 400 may modify any of packet processors 420 associated with a tenant in a manner that is not visible to other tenants associated with other packet processors 420 hosted by server 400.

Main packet processor 406 executing on server 400 is configured to direct packets, received at an underlay network address of NIC 404 for server 400, to one of multiple tenant-specific packet processors 420 each also executing on server and presenting virtual network addresses for respective VTEPs 408. In the example of FIG. 1, underlay network address is drawn from subnet 172.16.170.x/24. The virtual network address for VTEP 408A is drawn from subnet 210.210.210.21x/31, and virtual network address for VTEP 408B is drawn from subnet 212.212.212.21x/31. However, different subnets of different lengths may be used, typically according to a number of servers on which a tenant may have corresponding namespaces.

Each of packet processors 406, 420 implements a layers 2-4 network stack. That is, each of packet processors 406, 420 can process packets at OSI or TCP/IP layers 2, 3, and 4. Each of packet processors 406, 420 may implement one or more of a virtual switch, a virtual router, a gateway, a firewall, a load balancer, or other network function/service. Each of packet processors 406, 420 may process, for instance, any one or more of Ethernet, MPLS, IPv4, IPv6, ARP, VXLAN, VPN, overlay/virtual, tunneled (e.g. GRE, IP-in-IP, etc.), or other type of packet to implement multiple VTEPs 408 each associated with one or more VNIs 410, according to one or more aspects of this disclosure. Any of packet processors 406, 420 may implement a vector packet processor that is capable of processing multiple packets at a time. Each of packet processors 406, 420 includes a lookup table (not shown) for a data plane and can also participate in control plane, traffic management, and overlay operations. Each of packet processors 406, 420 may operate kernel space, similar to the Linux kernel network stack. However, any packet processors 406, 420 may execute in user space in some examples. Each of packet processor 420 may execute on a different processing core of server 400 (not shown).

Main packet processor 406 processes packets received at the underly (host) network address associated with NIC 404 and directs each packet to a particular one of packet processors 420 based on a virtual destination address of the outer header of the packet matching the virtual network address for the corresponding one of VTEPs 408 for that packet processor. In this example, packet processors 406, 420 may in this way be chained to provide service isolation among tenants using namespaces 419 that are commensurate with the respective tenant-specific VTEPs 408.

VXLAN uses an Ethernet/MAC in UDP encapsulation scheme where an original L2 frame is encapsulated by a VXLAN header and further encapsulated by a UDP-IP header, referred to herein as the “outer header.” This encapsulated packet can be further encapsulated by a tunnel header for transport across an underlay network as a tunneled packet.

For example, NIC 404 may receive a tunneled packet with a tunnel header having a destination network address that is the underlay (host) network address associated with NIC 404. Main packet processor 406 receives the tunneled packet and strips the tunnel header to obtain the outer packet having an IP header that includes a destination network address and a VXLAN header having a VNID field that indicates a VNI. Based on matching the destination network address to the virtual network address configured for VTEP 408A, packet processor 406 delivers the inner packet and VXLAN header to packet processor 420A associated with VTEP 408A. Packet processor 420A processes the VXLAN header to determine the VNID for the inner packet. For example, if the VNID of the VXLAN header matches VNI 410A, packet processor 420A may remove the outer header and deliver-based on a forwarding table associated with VNI 410A—the original packet to a destination workload having an interface with packet processor 420A. In the illustrated example, VNI 410A is associated with prefix 1.0.0.1/8, and VNI 410B is associated with 2.0.0.1/8. (This is true for both sets of VNIs 410 for separate VTEPs 408, illustrating the technical advantage of the described techniques to allow for overlapping VNI space for overlapping network address spaces.) The destination workload receives the original packet from packet processor 420A and processes the original packet. As noted above, the destination workload may implement an aspect of a tenant control plane.

Packet processors 420 may communicate packets with main packet processor 406 using a shared memory packet interface (memif). In general, a shared memory packet interface poll mode driver (PMD) allows for DPDK and any other client using memif (e.g., DPDK, packet processors 406 or 420) to communicate using shared memory. In some examples, main packet processor 406 is a memif server and packet processors 420 connect via sockets, created by main packet processor 406, as clients. The sockets permit sending and receiving raw packets through the kernel. In such examples, reference herein to “forwarding” or “directing” packets between main packet processor 406 and tenant-specific packet processors 420 refers to communicating packets using memif. Packet processor 406 may store a forwarding table or other mapping structure that maps the virtual network address for VTEP 408A to the memif interface for packet processor 420A and maps the virtual network address for VTEP 408B to the memif interface for packet processor 420B. In this way, packet processor 806 can direct received VXLAN traffic to the appropriate one of packet processors 820 based on the destination network address of the outer header for VXLAN traffic. However, other examples of interfaces between main packet processor 806 and tenant-specific packet processors 820 are possible, such as tap, veth, a virtual bridge, a virtual network interface, TCP sockets, other shared memory, or other inter-process communication. Workloads of tenant control planes 814 and packet processors 820 may communicate packets in a similar manner.

Packet processors 406, 420 also send traffic out via NIC 404 onto the IP core 402 to remote destinations (e.g., other servers hosting destination workloads). To reduce flooding of BUM traffic across IP core 402, each of packet processors 420 generates BUM packets to be sent only to servers that host workloads associated with the tenant for the packet processor. For example, the tenant associated with packet processor 420A and namespace 419A may also have an associated namespace on multiple other servers (though not all servers in the cluster). These servers are configured with a VTEP network address assigned to the tenant, in a manner similar to the VTEPs 408 configured for server 400. BUM traffic that is to be flooded should only be sent to servers that host a VTEP assigned to the tenant associated with the BUM traffic.

To limit BUM traffic flooding, controller 332 configures flood lists 413A-413B (collectively, “flood lists 413”). Each of flood lists 413 stores entries specifying underlay (host) network addresses for the corresponding tenant. For example, flood list 413A may store network addresses A1 for server S1 and A2 for server S2, where A1 and A2 are drawn from prefix 172.16.170.x/24 (same as for server 400). Controller 332 configures flood list 413A in this way because servers S1 and S2 host namespaces for the tenant associated namespace 419A. Controller 332 configures flood list 413B in a similar manner, but with network addresses for servers hosting namespaces for the tenant associated with namespace 419B.

Based on flood list 413A, packet processor 420A may generate and forward BUM traffic to VTEPs 408A configured in remote servers. To continue the above example, for a BUM packet P, packet processor 420A may generate packet P1 having a tunnel header indicating destination network address A1 and may generate packet P2 having a tunnel header indicating destination network address A2. The outer header including the VXLAN header will be similar for both packets P1 and P2, for the VTEP virtual network address is the same for all of the tenant's namespaces operating on various hosts (S1 and S2 in this example). Packet processor 420A may deliver P1 and P2 to packet processor 406 for output via NIC 404.

In this way, packet processors 420 may generate and send BUM traffic to reduce the number of servers to which BUM traffic is flooded. As each tenant is assigned a VTEP virtual network address specific to that tenant, packet processor 406 generates and forwards BUM traffic to the particular destination servers hosting namespaces/workloads for the tenant and avoids unnecessarily sending BUM traffic to servers that do not host namespaces/workloads for the tenant. Packet processor 406 may thereby reduce the need for frame replication of BUM packets and the need for Ethernet VPN-VXLAN (EVPN-VXLAN) to manage flooding.

Agent 415 may receive tenant configuration changes and update routes in tenant routing tables 412A-412B or addresses in flood list 413. Agent 415 may receive configuration changes to update a VTEP such as VTEP 408A. The service and tenant isolation advantages provided by the techniques described herein may limit failures due to configuration changes to individual tenants, for an update to one namespace 419 other tenants associated with other namespaces. For example, controller 332 via agent 415 updates namespace 419A with a received configuration change that causes packet processor 420A to misbehave. As namespace 419A is logically independent from namespace 419B, namespace 419B is not negatively impacted.

VNIs 410 represent one or more VXLAN network identifiers. As shown in FIG. 4A, VNIs 410 are logically associated with VTEPs 408, and provide VXLAN network identifiers for sub-networks or sub-tenants reachable using the VTEP. VNIs 410, while illustrated as including VNI 410A and VNI 410B, may include a plurality of VNIs assigned to each tenant of server 400.

Because separate VTEPs 408 are used for separate tenants, VNIs 410 may overlap across the tenants of server 400. As illustrated in FIG. 4A, VTEP 408A is shown as having interfaces for VNI 410A and VNI 410B, while VTEP 408B is also shown as having interfaces for VNI 410A and VNI 410B. Server 400 may configure VTEPs 408 with a same VNI for each tenant of server 400. In this way, the techniques may enable overlapping VNIs, IPs prefixes/addresses, virtual routing and forwarding instances, and layer-7 applications without interfering with another tenant using the separate namespace 819 enabled by the use of separate VTEPs 408.

As described above, each of tenant control planes 414 may execute a routing protocol process that executes one more routing protocols, such as Border Gateway Protocol (BGP) or an interior gateway protocol (IGP), to exchange routing information with other routers and control planes. Each of tenant control planes 414, as illustrated, is an abstraction of one or more workloads executing in the different VNIs 410 for the tenant. Packet processor 420A, for example, may route packets received at VNIs 410 to tenant control plane 414A according to tenant routing table 412A, which may specify routing and/or forwarding information for the tenant VNIs for VTEP 408A. Routing information may include routes to prefixes advertised among tenant control plane 414A processes, and may have next hops that are other VTEPs 408A located at remote servers hosting workloads configured with addresses in the advertised prefixes.

Tenant control planes 414 may manage configuration of one or more network components in the network system. In an example, tenant control planes 414 each implement a BGP control plane for advertising reachability of workloads. Each of tenant control planes 414 may run one or more services without interfering with services executing on other tenant control planes.

Server 400 may manage the resource consumption of tenant control planes 414. For example, server 400 may modify resource allocations such as processing and memory allocation to one or more tenants of server 400. Server 400 may manage the resource allocation among the tenants of server 400 without interfering with the resource allocations to other tenants, for each tenant is assigned its own VTEP. In an example, server 400 may cap resource allocation for processing packets received at VTEP 408A without interfering with the performance of tenant control plane 414B. In another example, server 400 may provide a data plane with fixed resource allocation for each tenant on the same OS kernel.

The techniques of this disclosure may provide one or more advantages. Server 400 may instantiate multiple instances of tenant-specific packet processors 420. In addition, server 400 may be configured with a VTEP for each of the tenants and, thereby, each of packet processors 420. By assigning a different VTEP to each of the tenants, server 400 may enable tenant-specific flood lists 413 that reduce the number of destinations for a flood message. In addition, server 400 may be configured with overlapping VNIs for multiple tenants and use a VTEP to differentiate between tenants to increase the availability of VXLAN VNI addresses globally, and reduce the need for MPLS backbone routers. Additionally, VTEPs specific to each tenant may improve service isolation between tenants compared to a design where tenants share a VTEP. Rather than unpacking a VXLAN packet at a shared VTEP where the packet could leak to other tenants due to misconfiguration, for instance, main packet processor 406 first demultiplexes packets by VTEPs 408 to tenant-specific processes 421, which can then process VXLAN packets that are specific to individual tenants. Further, the techniques of this disclosure may enable overlapping VNIs, IPs, VRFs, and layer-7 applications within a tenant Linux namespace domain without interfering with the domains of other tenants.

In the example of FIG. 4B, data center 440 and data center 442 are connected to and exchange traffic via IP core network 402 (illustrated as “IP core 402”). Controller 332 is depicted separately and having connectivity to data centers 440, 442 via IP core 402. However, controller 332 may reside in one of data centers 440, 442. Data center 440 hosts one or more servers 421A-421N (collectively, “servers 421”) connected via an internal fabric, and data center 442 hosts one or more servers 422A-422N (collectively, “servers 422”) connected via an internal fabric. Server 400 of FIG. 4A may represent an example instance of any of servers 421, 422. Servers 421 and/or servers 422 may represent example instances of any of compute clusters 102, 114, or 118 of FIG. 1.

In various examples, servers 421, 422 may be deployed as physical clusters, virtual clusters, or a cloud-based cluster running in a private, hybrid, or a public cloud deployed by a cloud service provider. In some cases, any of servers 421, 422 are included in a compute cluster that represents a single management domain. The number of servers 820, 822 in each data center may be scaled to meet performance needs.

Any of servers 421, 422 may be configured in a manner similar to that described with respect to server 400 to implement and offer multiple control plane to one or more tenants and/or to otherwise segregate workloads. A control plane is a domain that determines policies for routing packets, such as among one or more NFVs, which may be hosted by data center 442 or data center 440.

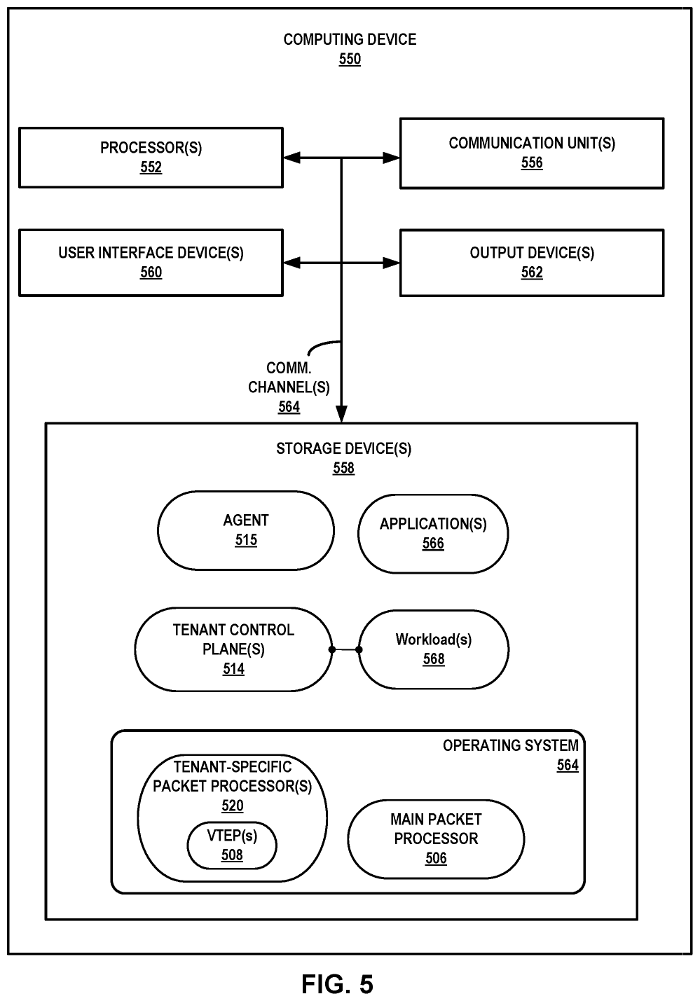

FIG. 5 is a block diagram of an example computing device 550, according to techniques of this disclosure. Computing device 550 may be configured to implement server 400 as illustrated in FIG. 4A. Computing device 550 may be a physical server located within a datacenter, a virtualized server, distributed computing environment, or other type of computing device. As illustrated in FIG. 5, computing device 550 includes processors 552, communication units 556, storage devices 558, user interface devices 560, and output devices 562.

As shown in the example of FIG. 5, computing device 550 includes one or more processors 552. Processors 552, in one example, are configured to implement functionality and/or process instructions for execution within computing device 550. For example, processors 552 may be capable of processing instructions stored in storage device 558. Examples of processors 552 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 558 may be configured to store information within computing device 550 during operation. Storage device 558, in some examples, is described as a computer-readable storage medium. In some examples, storage device 558 is a temporary memory, meaning that a primary purpose of storage device 558 is not long-term storage. Storage device 558, in some examples, is described as a volatile memory, meaning that storage device 558 does not maintain stored contents when the computer is turned off. Examples of volatile memories include random access memories (RAM), dynamic random access memories (DRAM), static random access memories (SRAM), and other forms of volatile memories known in the art. In some examples, storage device 558 is used to store program instructions for execution by processors 852. Storage device 558, in one example, is used by software or applications running on computing device 550 to temporarily store information during program execution.

Storage devices 558, in some examples, also include one or more computer-readable storage media. Storage devices 558 may be configured to store larger amounts of information than volatile memory. Storage devices 558 may further be configured for long-term storage of information. In some examples, storage devices 1008 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 550, in some examples, also includes one or more communication units 856. Computing device 550, in one example, utilizes communication units 856 to communicate with external devices via one or more networks, such as one or more wired/wireless/mobile networks. Communication units 556 may include a network interface card, such as an Ethernet card, an optical transceiver, a radio frequency transceiver, or any other type of device that can send and receive information. In some examples, computing device 550 uses communication unit 556 to communicate with an external device.

Computing device 550, in one example, also includes one or more user interface devices 560. User interface devices 560, in some examples, are configured to receive input from a user through tactile, audio, or video feedback. Examples of user interface devices(s) 550 include a presence-sensitive display, a mouse, a keyboard, a voice responsive system, video camera, microphone, or any other type of device for detecting a command from a user. In some examples, a presence-sensitive display includes a touch-sensitive screen.

One or more output devices 562 may also be included in computing device 550. Output device 562, in some examples, is configured to provide output to a user using tactile, audio, or video stimuli. Output device 562, in one example, includes a presence-sensitive display, a sound card, a video graphics adapter card, or any other type of device for converting a signal into an appropriate form understandable to humans or machines. Additional examples of output device 562 include a speaker, a cathode ray tube (CRT) monitor, a liquid crystal display (LCD), or any other type of device that can generate intelligible output to a user.

Computing device 550 may include operating system 564. Operating system 564, in some examples, facilitates the operation of components of computing device 550. For example, operating system 564, in one example, facilitates execute operations of one or more applications of storage devices 558 including one or more applications 566, agent 515, tenant control plane(s) applications (which may include workload(s) 568), as well as tenant-specific packet processor(s) 520 and main packet processor 506. Tenant-specific packet processor(s) 520 and main packet processor 506 are shown as kernel-based applications in FIG. 5.

According to configuration data and commands received by agent 515, operating system 564 may instantiate multiple instances of tenant-specific packet processors 520. For example, operating system 564 may instantiate an instance of packet processor 520 for each tenant having a tenant control plane implemented on computing device 550. In another example, operating system 564 may chain one or more instances of packet processors 520 and main packet processor 506 to implement tenant-specific VTEPs and isolation, according to techniques of this disclosure.

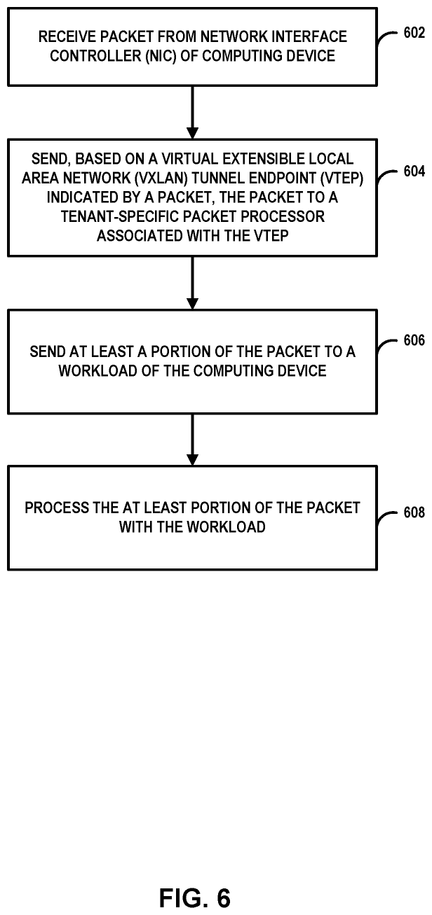

FIG. 6 is a flow diagram illustrating an example operation according to techniques of this disclosure. For the purposes of clarity, FIG. 6 will be discussed in reference to the elements of FIG. 4A.

A main packet processor, such as main packet processor 406, of a computing device, such as server 400, receives a packet from a network interface controller, such as NIC 404 (602). Main packet processor 406 may strip a tunnel header of the packet to obtain an outer packet having an IP header that includes a destination network address and a virtual extensible local area network (VXLAN) header having a VNID field that indicates a VNI. Main packet processor 406 may match the destination network address to a virtual network address configured for a VXLAN tunnel endpoint (VTEP), such as VTEP 408A.

Main packet processor 406 sends, based on a VTEP indicated by the packet, the packet to a tenant-specific packet processor associated with the VTEP, such as packet processor 420A (604). Main packet processor 406 may execute one or more instances of tenant-specific packet processors 420. Packet processor 420A may communicate with main packet processor 406 using a shared memory packet interface (memif).

Packet processor 420A sends at least a portion of the packet to a workload of server 400 (606). Packet processor 420A may process a VXLAN header to determine the VNID. Packet processor 420A may deliver the at least a portion of the packet to a workload having an interface with packet processor 420A and associated with the VNID.

The workload processes at least a portion of the packet (608). The workload may process the at least a portion of the packet, e.g., as part of implementing a tenant control plane, such as tenant control plane 414A.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset.

Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

What is claimed is:

1. A computing device comprising:
a network interface controller (NIC); and
processing circuitry having access to storage media encoded with instructions, the processing circuitry configured to:
receive, by a main packet processor, a packet from the NIC;
send, by the main packet processor, based on a virtual extensible local area network (VXLAN) tunnel endpoint (VTEP) indicated by the packet, the packet to a tenant-specific packet processor associated with the VTEP;
send, by the tenant-specific packet processor, at least a portion of the packet to a workload; and
process, by the workload, the at least a portion of the packet.

2. The computing device of claim 1,
wherein the main packet processor processes the packet with a first network stack, and
wherein the tenant-specific packet processor processes the packet with a different, second network stack.

3. The computing device of claim 1,
wherein the packet comprises a first packet,
wherein the tenant-specific packet processor comprises a first tenant-specific packet processor,
wherein the VTEP comprises a first VTEP,
wherein the workload comprises a first workload associated with a first tenant, and
wherein the processing circuitry is configured to:
receive, by the main packet processor, a second packet from the NIC;
send, by the main packet processor, based on a second VTEP indicated by the second packet, the second packet to a second tenant-specific packet processor associated with the second VTEP;
send, by the second tenant-specific packet processor, at least a portion of the second packet to a second workload associated with a second tenant; and
process, by the second workload, the at least a portion of the second packet.

4. The computing device of claim 3,
wherein the first VTEP is associated with a first virtual network address, and
wherein the second VTEP is associated with a different, second virtual network address.

5. The computing device of claim 3,
wherein the main packet processor processes the packet with a first network stack,
wherein the first tenant-specific packet processor processes the packet with a different, second network stack, and
wherein the first tenant-specific packet processor processes the packet with a different, third network stack.

6. The computing device of claim 1,
wherein the VTEP is associated with a virtual network address, and
wherein the main packet processor sends the packet to the tenant-specific packet processor associated with the VTEP based on a destination network address of the packet matching the virtual network address associated with the VTEP.

7. The computing device of claim 1, wherein the workload implements a tenant control plane for a tenant associated with the VTEP.

8. The computing device of claim 1, further comprising:
a flood list for a tenant associated with the VTEP, the flood list storing an entry specifying an underlay network address for another computing device,
wherein the packet comprises a first packet;
wherein the processing circuitry is configured to:
receive, by the tenant-specific packet processor, an original packet from the workload;
generate a second packet comprising:
a tunnel header comprising the underlay network address for the another computing device, an
outer header comprising a virtual network address associated with the VTEP,
a VXLAN header, and
the original packet;
output the second packet via the NIC to the another computing device.

9. The computing device of claim 8, wherein the processing circuitry is configured to:
receive, by an agent, the entry;
store the entry to the flood list.

10. The computing device of claim 1,
wherein the main packet processor and the tenant-specific packet processor are configured with a shared memory interface,
wherein the main packet processor is configured to send, via the shared memory interface, the packet to a tenant-specific packet processor associated with the VTEP.

11. The computing device of claim 1,
wherein the main packet processor and the tenant-specific packet processor execute in separate namespaces.

12. A computing system comprising:
a first computing device configured with a first virtual extensible local area network (VXLAN) tunnel endpoint (VTEP) for a tenant, the first VTEP having an interface configured with a virtual network address; and
a second computing device configured with a second virtual extensible local area network (VXLAN) tunnel endpoint (VTEP) for the tenant, the second VTEP having an interface configured with the virtual network address.

13. The computing system of claim 12, wherein the first computing device comprises:
a main packet processor configured to obtain a packet,
wherein the main packet processor is further configured to send, based on the packet having a destination virtual network address that matches the virtual network address configured for the interface of the first VTEP, the packet to a tenant-specific packet processor associated with the first VTEP;
the tenant-specific packet processor, configured to send at least a portion of the packet to a workload; and
the workload, configured to process the at least a portion of the packet.

14. A method comprising:
receiving, by a main packet processor of a computing device, a packet from a network interface controller (NIC) of the computing device;
sending, by the main packet processor, based on a virtual extensible local area network (VXLAN) tunnel endpoint (VTEP) indicated by the packet, the packet to a tenant-specific packet processor of the computing device, the tenant-specific packet processor associated with the VTEP;
sending, by the tenant-specific packet processor, at least a portion of the packet to a workload of the computing device; and
processing, by the workload, the at least a portion of the packet.

15. The method of claim 14,
wherein the main packet processor processes the packet with a first network stack, and
wherein the tenant-specific packet processor processes the packet with a different, second network stack.

16. The method of claim 14,
wherein the packet comprises a first packet,
wherein the tenant-specific packet processor comprises a first tenant-specific packet processor,
wherein the VTEP comprises a first VTEP,
wherein the workload comprises a first workload associated with a first tenant, the method further comprising:
receiving, by a main packet processor, a second packet from the NIC;
sending, by the main packet processor, based on a second VTEP indicated by the second packet, the second packet to a second tenant-specific packet processor associated with the second VTEP;
sending, by the second tenant-specific packet processor, at least a portion of the second packet to a second workload associated with a second tenant; and
processing, by the second workload, the at least a portion of the second packet.

17. The method of claim 16,
wherein the first VTEP is associated with a first virtual network address, and
wherein the second VTEP is associated with a different, second virtual network address.

18. The method of claim 14,
wherein the VTEP is associated with a virtual network address, and
sending, by the main packet processor, the packet to the tenant-specific packet processor associated with the VTEP based on a destination network address of the packet matching the virtual network address associated with the VTEP.

19. The method of claim 14,
storing a flood list for a tenant associated with the VTEP, the flood list storing an entry specifying an underlay network address for another computing device,
wherein the packet comprises a first packet;
the method further comprising:
receiving, by the tenant-specific packet processor, an original packet from the workload;
generating a second packet comprising:
a tunnel header comprising the underlay network address for the another computing device,
an outer header comprising a virtual network address associated with the VTEP,
a VXLAN header, and
the original packet;
outputting the second packet via the NIC to the another computing device.

20. The method of claim 14, wherein the main packet processor and the tenant-specific packet processor execute in separate namespaces.
